(19) United States
(12) Patent Application Publication
(10) Pub. No.: US 2017/0061468 A1
(43) Pub. Date: Mar. 2, 2017

(54) PARALLEL MEMBER INTERACTION ESTIMATION USING ONSITE AND OFFSITE DATA

(71) Applicant: Linkdedln Corporation, Mountain View, CA (US)

(72) Inventors: Siyu You, Santa Clara, CA (US); Yamin Htun, Milpitas, CA (US)

(21) Appl. No.: 14/841,264

(22) Filed: Aug. 31, 2015

(51) Int. Cl. G06Q 30/02; G06Q 50/00; H04L 29/08

(52) U.S. Cl. CPC G06Q 30/0242; H04L 67/306; G06Q 30/0277; G06Q 50/01

(57) ABSTRACT

Systems and methods include, for each sponsored content campaign, accessing, during a predetermined access time, member profile data and activity data from a database of a social networking system. Member profile data and activity data that is not accessible during the predetermined access time is not accessed. During a predetermined time including the predetermined access time, an onsite predicted interaction rate, by the member, with sponsored content items is determined based the member profile data and the activity data. For each of the sponsored content campaigns, within the predetermined time, an offsite predicted interaction rate, by the member, with sponsored content items is calculated based on data obtained from a third party. For each of the sponsored content campaigns, a predicted interaction rate, by the member, is determined based on the onsite predicted interaction rate and the offsite predicted interaction rate.

### TECHNICAL FIELD

The subject matter disclosed herein generally relates to the parallel processing of onsite and offsite data to estimate a member interaction with sponsored content items.

### BACKGROUND

Online social networking systems conventionally obtain content items from multiple content item sources. The content items as obtained may then be displayed to users of the social network on a user interface, such as a feed, dedicated windows or spaces on a visual display, separate windows, and the like. Content item sources may include user profiles and changes thereto stored by the social network, entities that provide sponsored content or databases in which the content items are stored, and organic content recommendation engines, such as engines that provide particular types of content, including job recommendations, recommended connections with members of the social network, and content that other members and users of the social network have found interesting.

### BRIEF DESCRIPTION OF THE DRAWINGS

Some embodiments are illustrated by way of example and not limitation in the figures of the accompanying drawings.

FIG. 1 is a block diagram illustrating various components or functional modules of a social network system, consistent with some examples.

FIG. 2 is a flowchart for providing a sponsored content item to a member of the online social networking system, in an example embodiment.

FIG. 3 is a block diagram of the sponsored content module, in an example embodiment.

FIG. 4 is a flowchart for implementing response prediction, in an example embodiment.

FIG. 5 is a flowchart for bid optimization using the predicted response rate, in an example embodiment.

FIG. 6 is a block diagram illustrating components of a machine, according to some example embodiments.

### DETAILED DESCRIPTION

Example methods and systems are directed to the parallel processing of onsite and offsite data to estimate a member interaction with sponsored content items. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

The social networking system conventionally obtains sponsored content items, such as advertisements and such, according to organized sponsored content campaigns. The sponsored content campaigns may include content items for display to users of the social networking system, desired characteristics of users to whom the sponsored content items are ultimately displayed, and a bid or bid structure for displaying and/or for resultant interactions with the sponsored content items. Thus, for instance, a campaign may specify that, for a user meeting predefined profile data points, the sponsor of the campaign will pay a first amount of money if a sponsored content item is displayed to the user and a second amount of money if the user interacts or engages with the content item, such as by selecting a link, entering a comment, sharing the content item, “liking” or otherwise giving an indication of approval of the content item, and so forth.

Relatively more complicated advertising campaigns may also be utilized, such as those utilizing real-time bidding (RTB) mechanisms known in the art. In one example implementation, when a user goes to a third party site, a publishing of the site may transmit a request to a sponsored content or advertising exchange. The exchange may transmit a request for a sponsored content item with a value placed on an interaction with the sponsored content item. A bidding system receives bids from sponsoring entities to place their respective content items on the third party site, with the highest bidder winning the right to place the sponsored content item. The value of the campaign and/or the display of the sponsored content items of the campaign to the social networking system, then, is dependent on the relative financial values that can be obtained by displaying the campaigns/sponsored content items to users of the online social networking system and/or the third party site.

Owing to the often increased value of user interaction with sponsored content items, the social networking system may seek to maximize revenue by directing sponsored content items to users who are likely to interact with the content items. Because the online social networking system may be managing multiple campaigns concurrently, the social networking system has the option to choose between and among the sponsored content items submitted by the campaigns for the best bid values. Based on those bid values, the social networking system may then seek to direct the sponsored content items to the users who meet the desired profile characteristics of the campaign and who are the most likely to interact with the sponsored content items.

As noted, sponsored content can be directed to particular viewers of the content, e.g., particular users or members of the social networking system. However, the social networking system may not “know” which user is about to access the social networking system until the user actually attempts to view or otherwise load a webpage or other social networking resource. Thus, in many circumstances the social networking system advantageously determines sponsored content items to display to the user very rapidly in order to allow the page to load for the user acceptably quickly. However, accessing conventional databases for profile information about the user may be relatively slow. For instance, according to contemporary standards, while it may be desirable to obtain the desired profile information within tens of milliseconds, to download all of the desired profile information from databases may at times take hundreds of milliseconds.

A social networking system has been developed which is not reliant solely on stored profile information of a member of the social networking system in order to identify sponsored content for display to the member. Rather, the social networking system accesses what profile information from the databases that can be accessed within a predetermined time period. In parallel, the social networking system accesses cached information for recent information concerning interactions and the circumstances of those interactions. The information may come from the social networking system activities or information is generated from sources that are not included in the social networking system, e.g., “offline” sources. The social networking system then utilizes the database profile information and the cached information to generate a predicted interaction rate with given sponsored content items. The predicted interaction rate is then utilized to identify a sponsored content item for display to the member. Thus, the social networking system may reliably obtain desired information within a timing requirement.

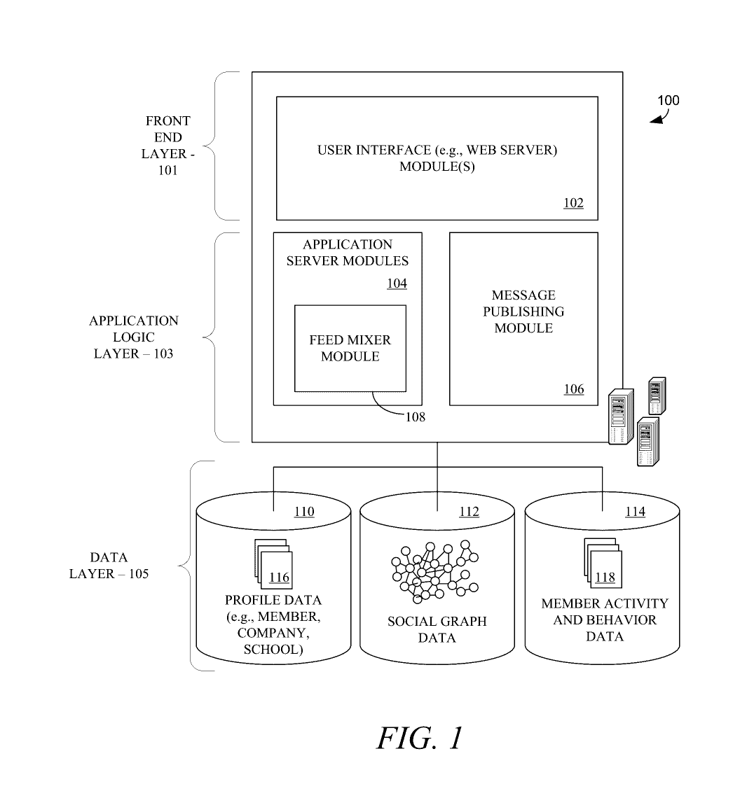

FIG. 1 is a block diagram illustrating various components or functional modules of a social networking system 100, consistent with some examples. A front end 101 consists of a user interface module (e.g., a web server) 102, which receives requests from various client-computing devices, and communicates appropriate responses to the requesting client devices. For example, the user interface module(s) 102 may receive requests in the form of Hypertext Transport Protocol (HTTP) requests, or other web-based, application programming interface (API) requests. An application logic layer 103 includes various application server modules 104, which, in conjunction with the user interface module(s) 102, may generate various user interfaces (e.g., web pages, applications, etc.) with data retrieved from various data sources in a data layer 105. In some examples, individual application server modules 104 may be used to implement the functionality associated with various services and features of the social network service. For instance, the ability of an organization to establish a presence in the social graph of the social network system 100, including the ability to establish a customized web page on behalf of an organization, and to publish messages or status updates on behalf of an organization, may be services implemented in independent application server modules 104. Similarly, a variety of other applications or services that are made available to members of the social network service may be embodied in their own application server modules 104. Alternatively, various applications may be embodied in a single application server module 104. In some examples, the social network system 100 includes a content item publishing module 106, such as may be utilized to receive content, such as electronic messages, posts, links, images, videos, and the like, and publish the content to the social network.

One or more of the application server modules 104, the content item publishing module 106, or the social network system 100 generally may include a sponsored content module 108. As will be disclosed in detail herein, the sponsored content module 108 obtains sponsored content campaigns and associated sponsored content items. When a member of the social networking system 100 loads a page or other application of the social networking system 100, the sponsored content module 108 identifies a sponsored content item for display to the member based on stored profile data and activity data of the member, as stored in databases disclosed herein, and based on cached data, as cached in one or both of the front end layer 101 and the application logic layer 103. The content publishing module 106 then publishes the sponsored content item and outputs the sponsored content item for display to the member.

The sponsored content module 108 may be implemented on a separate server or may be part of a server that provides other portions of the social network system 100. Thus, it is to be understood that while the sponsored content module 108 is described as an integral component of a social network, the principles described herein may be applied without the sponsored content module 108 being an integral part of a social network.

As illustrated, the data layer 105 includes, but is not necessarily limited to, several databases 110, 112, 114, such as a database 110 for storing profile data 116, including both member profile data as well as profile data for various organizations. Consistent with some examples, when a person initially registers to become a member of the social network service, the person may be prompted to provide some personal information, such as his or her name, age (e.g., birthdate), gender, interests, contact information, home town, address, the names of the member's spouse and/or family members, educational background (e.g., schools, majors, matriculation and/or graduation dates, etc.), employment history, skills, professional organizations, and so on. This information is stored, for example, in the database 110. Similarly, when a representative of an organization initially registers the organization with the social network service, the representative may be prompted to provide certain information about the organization. This information may be stored, for example, in the database 110, or another database (not shown). With some examples, the profile data may be processed (e.g., in the background or offline) to generate various derived profile data. For example, if a member has provided information about various job titles the member has held with the same or different companies, and for how long, this information can be used to infer or derive a member profile attribute indicating the member's overall seniority level, or seniority level within a particular company. With some examples, importing or otherwise accessing data from one or more externally hosted data sources may enhance profile data for both members and organizations. For instance, with companies in particular, financial data may be imported from one or more external data sources, and made part of a company's profile.

Once registered, a member may invite other members, or be invited by other members, to connect via the social network service. A “connection” may require a bi-lateral agreement by the members, such that both members acknowledge the establishment of the connection. Similarly, with some examples, a member may elect to “follow” another member. In contrast to establishing a connection, the concept of “following” another member typically is a unilateral operation, and at least with some examples, does not require acknowledgement or approval by the member that is being followed. When one member follows another, the member who is following may receive status updates or other messages published by the member being followed, or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data feed or content stream. In any case, the various associations and relationships that the members establish with other members, or with other entities and objects, are stored and maintained within the social graph database 112.

Activities by users of the social network system 100 may be logged as activities 118 in the activity and behavior database 114. Such activities may include search terms, interactions with search results and subsequent engagement with the subject of search results, scores assigned to such search terms, as disclosed herein, communication with others via the social network, engagement with content items posted on the social network, joining groups, following entities, and so forth.

The social network service may provide a broad range of other applications and services that allow members the opportunity to share and receive information, often customized to the interests of the member. For example, with some examples, the social network service may include a photo sharing application that allows members to upload and share photos with other members. With some examples, members may be able to self-organize into groups, or interest groups, organized around a subject matter or topic of interest. With some examples, the social network service may host various job listings providing details of job openings with various organizations.

Although not shown, with some examples, the social network system 100 provides an application programming interface (API) module via which third-party applications can access various services and data provided by the social network service. For example, using an API, a third-party application may provide a user interface and logic that enables an authorized representative of an organization to publish messages from a third-party application to various content streams maintained by the social network service. Such third-party applications may be browser-based applications, or may be operating system-specific. In particular, some third-party applications may reside and execute on one or more mobile devices (e.g., phone, or tablet computing devices) having a mobile operating system.

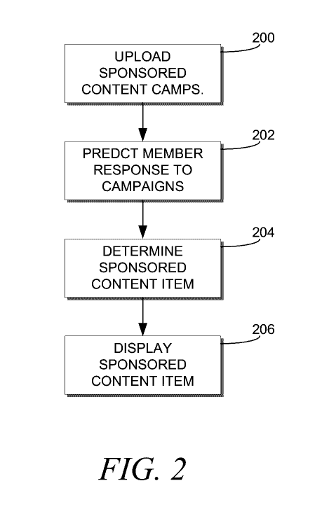

FIG. 2 is a flowchart for providing a sponsored content item to a member of the online social networking system 100, in an example embodiment. While the flowchart, and subsequent flowcharts disclosed herein, are described with respect to the social networking system 100 in particular, it is to be recognized and understood that the principles disclosed herein may be applied and utilized with any suitable system. As such, the description with respect to the social networking system 100 is for illustration and not limitation.

At 200, multiple sponsored content campaigns are uploaded to the sponsored content module 108. The sponsored content campaigns include various information related to conducting the campaign and variously sponsored content items and/or links or other mechanisms for accessing sponsored content items remotely for the campaign. The information for conducting the campaign includes a bid or bid scheme and, optionally, profile information that specifies desired targets of the campaign. The bid specifies an amount of money or other compensation that will be paid to the social networking system 100 or to representatives or operators of the social networking system 100 upon a criterion being met. A bid scheme may specify multiple different bids or circumstances under which the criteria for paying a bid may be met along with specifying sponsored content items that are associated with the bids.

Thus, a first bid scheme may specify that the sponsoring entity will pay $0.001 every time a sponsored content item is displayed to a member of the social networking system 100 (an “impression”). $0.10 every time a member who does not meet all of the profile requirements interacts with the sponsored content item (e.g., by clicking on a link, commenting on the sponsored content item, sharing the content item, etc.) and $0.20 every time a member who does meet all of the profile requirements interacts with the sponsored content item, and so forth for a specified first sponsored content item or first sponsored content items. A second bid scheme may establish a different scheme of payment levels for a second sponsored content item or second sponsored content items. While these illustrated bid schemes are conventional and comparatively simple, it is to be recognized that relatively more complicated bid schemes, such as those related to RTB systems described herein, may be utilized as well and implemented herein the same way as the illustrative bid schemes.

Uploading the sponsored content campaign may include the sponsored content items of the campaign or links or other mechanisms for accessing the sponsored content items. Thus, in various examples, uploading the sponsored content campaigns does not necessarily involve uploading the sponsored content items themselves but may involve uploading information concerning which sponsored content items should be accessed from external systems.

At 202, the sponsored content module 108 predicts a response of a given member of the social networking system to some or all of the sponsored content items associated with the various sponsored content campaigns. As will be disclosed in detail here, the sponsored content module 108 accesses some or all of the databases 110, 112, 114 of the social networking system 100, the “onsite” information of the member. To the extent that the databases 110, 112, 114 do not return certain requested information within a predetermined time, that information is treated as missing and disregarded. The sponsored content module 108 then calculates an onsite predicted rate at which the member will interact with the various sponsored content items.

The sponsored content module 108 additionally accesses “offsite” information that is not stored in the databases 110, 112, 114 but rather is included or accessed in some relatively more volatile an quick-access form, such as in one or more system caches or in time-dependent electronic storage. The sources for the offsite information may, by definition, be able to be accessed, substantially or in their entirety, sufficiently quickly to allow the offsite information to be utilized within the timeframes disclosed herein. The offsite information may be information that does not necessarily fall into the various categories of profile data 116, activity data 118, and social graph data. Rather, the offsite information may include any suitable information possessed about the member, including information obtained from sources external to the social networking system 100. Offsite information may be obtained in particular, but without limitation, from third party sites that participate in RTB systems disclosed herein. As such, the offsite information may include data concerning interactions with sponsored content items by users of the third party site in addition to any other information that may be obtained in any of a variety of ways, such as by accessing offsite databases for profile information and so forth. The offsite information is then utilized to calculate an offsite predicted rate at which the member will interact with the various sponsored content items.

The onsite and offsite predicted rates are calculated in parallel and within a predetermined time period. As noted, to the extent that certain onsite information cannot be obtained so that the onsite predicted rate can be calculated within the predetermined time period, that information is considered missing disregarded. The offsite prediction is utilized, at least in part, as a substitute for or supplement to the missing onsite information. Because the offsite information is obtainable from a cache or other relatively more volatile source, the offsite information is known to be obtainable to allow the offsite predicted rate to be calculated within the predetermined time period. The predicted response rate of the member to the various sponsored content items are then determined based on onsite predicted rate and the offsite predicted rate, as will be disclosed in detail herein. One predicted response rate is calculated for each sponsored content item considered, e.g., a first predicted response rate for a first sponsored content item, a second predicted response rate for a second sponsored content item, and so forth.

At 204, the sponsored content module 108 utilizes the predicted response rates of the member to the various sponsored content items to determine an optimized sponsored content item for display to the user. Any of a variety of optimization strategies may be employed in various circumstances as desired. In various examples, the sponsored content module 108 provides valuation to a sponsored content item on behalf of the sponsoring entity, as will be disclosed in detail herein. A margin or service fee may optionally be applied as well. Alternatively, an arbitrage bidding scheme may be applied, as will further be disclosed herein.

At 206, the optimized sponsored content item is displayed to the member on a user interface presented to the member by the user interface module 102.

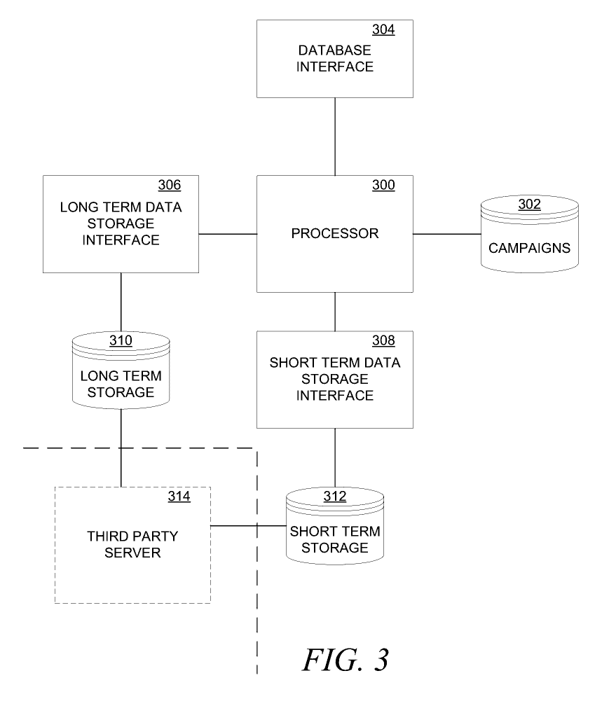

FIG. 3 is a block diagram of the sponsored content module 108, in an example embodiment. In the illustrated example, the sponsored content module 108 includes a processor 300 and a memory module 302 configured to store information related to uploaded sponsored content campaigns, as disclosed herein. The memory module 302 may be any suitable form of electronic storage or electronic memory as desired and as disclosed herein or known in the art.

The sponsored content module 108 further includes a database interface 304 configured to communicatively couple with the onsite databases 110, 112, 114. The sponsored content module 108 further includes a long term data source interface 306 and a short term data source interface 308. The long term data source interface 306 is coupled to and configured to interface with a long term data source 310 while the short term data source interface 308 is coupled to and configured to interface with a short term data source 312.

Not part of the sponsored content module 108 or the social networking system 100 generally, but remotely communicatively coupled to the data sources 310, 312 by a network interface, is a third party server 314 implementing a third party website, as disclosed herein. Information is exchanged between the third party server 314 and the sponsored content module 108 but the third party server 314 is not substantially subject to control of or by the social networking system 100. Rather, the third party server 314 may provide information to the social networking system 100 according to a predetermined process or according to a request from the social networking system 100. Data provided by the third party server 314 is stored in one or both of the data sources 310, 312 according to the parameters of the respective data sources 310, 312.

As illustrated, the data sources 310, 312 are distinct from the databases 110, 112, 114. In the illustrated example, the data sources 310, 312 are integral components of the sponsored content module 108. Alternatively, one or both of the data sources 310, 312 are accessible by the sponsored content module 108 by way of the respective interfaces 306, 308. In examples where a data source 310, 312 is a component of the sponsored content module 108 then the respective interface 306, 308 may be a conventional data bus or other intra-server communication mechanism or medium. In examples where a data source 310, 312 is not a component of the sponsored content module 108 then the respective interface 306, 308 may be or may utilize a network interface to send data requests to and receive data from the respective data source 310, 312. While two data sources 310, 312 and their associated interfaces 306, 308 are illustrated, it is to be recognized and understood that as few as one data source or three or more data sources may be implemented as desired.

In various examples, the data sources 310, 312 are cache memories. The cache memories may be implemented as conventional cache memories or as any electronic data storage that provides the performance characteristics described herein. The data sources 310, 312 are configured to store data for predetermined periods of time before the data is ultimately either deleted or stored elsewhere, such as in the databases 110, 112, 114. The amount of time the data sources 310, 312 store the data may be configurable depending on the circumstances of their particular implementation. In an example, the long term data source 310 stores data for fourteen (14) days while the short term data source 312 stores data for twenty-four (24) hours.

The data sources 310, 312 store any of a variety of information that is obtainable to the social networking system 100. That information may be generated by the operation of the social networking system 100 directly or may be obtained by the social networking system 100 from another source. For instance, if a user of the social networking system 100 links from the social networking system 100 to a third party site implemented by the server 314 then activities by the user on that third party site may be obtained by the social networking system 100 and stored on the data sources 310, 312. As such, the data sources 310, 312 may store offsite information that is not otherwise stored in the databases 110, 112, 114 or utilized by the social networking system 100 generally. The data sources 310, 312 may further cache onsite information that will ultimately be stored in the databases 110, 112, 114.

In various examples, the short term data source 312 may store effectively all data that is obtained by the social networking system 100. The data in the short term data source 312 may be transferred to the long term data source 310 and/or to a relevant database 110, 112, 114 or deleted. In an example, the long term data source 312 caches data that will be or has been stored in a database 110, 112, 114, as well as offsite data that may not ultimately be stored in a database 110, 112, 114, if such information is desired for consideration according to the mechanisms disclosed herein.

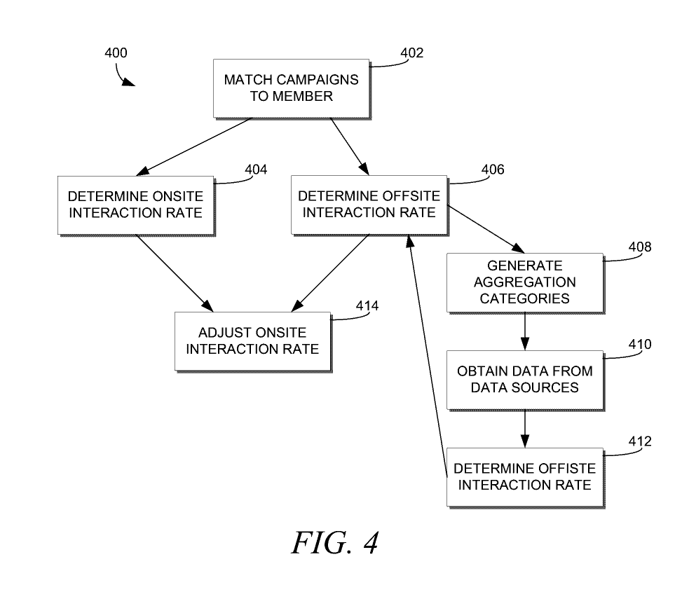

FIG. 4 is a flowchart 400 for implementing response prediction, in an example embodiment. The flowchart 400 may implement the response prediction operation 202 or any other suitable response prediction operation. Moreover, though the flowchart 400 may implement the response prediction operation 202, the response prediction operation 202 may be implemented by any other suitable mechanism. The flowchart 400 is presented with respect to determining a predicted response of a given member of the social networking system 100 to a variety of sponsored content items or to the sponsored content items that may be generated by or meet the specifications of a sponsored content campaign.

At 402, the sponsored content module 108 matches sponsored content campaigns to the member. In various examples, if a sponsored content campaign specifies required conditions for being presented to the member (e.g., a required gender, age, profession, etc.), and the member does not meet one or more required conditions, then the sponsored content campaign is not a match for the member. It is to be recognized and understood that the requirements for a match may be varied and may encompass combinations of profile data 116 of the member or any of a variety of other conditions. In various examples, a matched sponsored content campaign is any campaign that does not fail a matching condition. The matched sponsored content campaigns are then utilized throughout the rest of the flowchart 400 while the sponsored content campaigns that do not match the member are disregarded.

At 404, the sponsored content module 108 determines an onsite predicted interaction rate for sponsored content items of the matched sponsored content campaigns. The sponsored content module 108 transmits a command to the databases 110, 112, 114 for data that may be utilized in determining the predicted interaction rates by the member with the various content items. The data may relate to the member specifically and/or to other members and users of the social networking system 100. The databases 110, 112, 114 return the information and the sponsored content module 108 utilizes that information to determine the onsite predicted interaction rate individually for the various content items. Mechanisms for determining an onsite predicted interaction rate are disclosed in detail in U.S. Patent Application Publication No. 2015/0095154, PROVIDING SPONSORED SOCIAL NETWORK CONTENT, U.S. Patent Application Publication No. 2015/0039406, INDEPENDENT TARGETED SPONSORED CONTENT MANAGEMENT SYSTEM AND METHOD, U.S. Patent Application Publication No. 2015/0046278, SYSTEM AND METHOD FOR POSITIONING SPONSORED CONTENT IN A SOCIAL NETWORK INTERFACE, and U.S. Patent Application Publication No. 2015/0046515, SYSTEM AND METHOD FOR POSITIONING SPONSORED CONTENT IN A SOCIAL NETWORK INTERFACE, all of which are incorporated herein by reference in their entirety.

In general and without limitation, data from the databases 110, 112, 114 may be utilized to establish both how likely the member is to interact with a given sponsored content item by comparing how that member has interacted with other content items in the past and how other members similar to the member have interacted with the given sponsored content item in the past. As such, the onsite predicted interaction rate may be based, at least in part, on data from the databases 110, 112, 114 for any member of the online social networking system and any activity data related to the member or to the given sponsored content item, in addition to any other data that might be utilize as desired.

The determination of the onsite predicted interaction rate occurs within a predetermined time period. That predetermined time period is broken down into a data access time period and a computation time period. The data access time period includes the time to command the databases 110, 112, 114 to transmit the requested data and the databases 110, 112, 114 to actually transmit the data to the sponsored content module 108. The computation time period is the amount of time the processor 300 has to calculate the predicted interaction rate for the various sponsored content items. The data access time period and the computation time period are likewise predetermined in their length. To the extent that data that is requested from the databases 110, 112, 114 is not returned during the data access time period, that data is not utilized during the computation time period.

In an example, the predetermined time period is ten (10) milliseconds. The ten (10) milliseconds is broken down into nine (9) milliseconds for the data access time period and one (1) millisecond for the computation time period. It is to be recognized that the predetermined time period may be broken down however is deemed desirable under various implementation circumstances. However, the breakdown remains fixed during the implementation of the operation 402 and, to the extent that requested data does not arrive during the data access time period, the data is not available during the computation time period. Thus, for instance, if not all of the data related to past interactions with the subject sponsored content item is received during the data access time period then the onsite predicted interaction rate is computed without the missing data during the computation time period.

At 406, in parallel with the generation of the onsite predicted interaction rate in operation 404, the processor calculates offsite interaction rates based on data accessed from the data sources 310, 312. It is noted that the offsite interaction rates may include information that is generated internally to the social networking system 100 if that information has been stored in one of the data sources 310, 312. Thus, the term “offsite interaction rate” may include onsite information accessed from the data sources 310, 312.

At 408, the processor generates data aggregation categories for the member (for this example, John Doe) to whom a sponsored content item is to be displayed. In an example, the data aggregation categories are based on data points that have one each of the following types: data source type; member exposure type; and data characteristic type. In such an example, for the data source type, each data aggregation category includes data from one data source 310, 312. For the member exposure type, each data aggregation category includes data relating to whether a sponsored content item was shown to the member and whether the member interacted with the sponsored content item. For the data characteristic type, each data aggregation category includes one of the following characteristics: that the data relates to the member; that the data relates to the type of application from which the data derives (e.g., a personal computer, a mobile device app, etc.); that the data relates to a particular sponsored content campaign; that the data relates to a particular sponsoring entity; that the data relates to a particular sponsored content application (e.g., a popup window, a sidebar in a browser window, an in-line content item in a feed, etc.); and that the data relates to a sponsored content campaign type (e.g., RTB, etc).

Each combination of [one data source type, one member exposure type, and one data characteristic type] produces a separate data aggregation category. Thus, for instance, a first data aggregation category includes data items that [were retrieved from the long term data source 310; relate to member interaction with a content item; and pertain to member John Doe]. A second data aggregation category includes data items that [were retrieved from the long term data source 310; relate to member interaction with a content item; and were generated from a mobile device app]. A third data aggregation category includes data items that [were retrieved from the short term data source 312; relate to member interaction with a content item; and pertain to member John Doe]. And so forth. Given that, in the above example, there are two data source types, two member exposure types, and six data characteristic types, there are 2×2×6=24 data aggregation categories, three (3) of which are illustrated specifically above and twenty-one (21) of which may be inferred.

While the various data types are presented for illustration, these are not presented for limitation. It is to be recognized and understood that any of the data types may be omitted and any of a variety of data types may be added as desired and as can be supported by the resources of the sponsored campaign module 108.

At 410, for each of the data aggregation categories, the processor 300 obtains data from the data sources 310, 312 that match the types of one or more of the categories. For instance, a piece of data that is obtained from the long term data source 310 that relates to an interaction by member John Doe with a sponsored content item from a sponsored content campaign X by Company Y on a mobile device app would be assigned to at least four different data aggregation categories in the example provided above, e.g., [long term data source 310; member interaction; John Doe]; [long term data source 310; member interaction; mobile device]; [long term data source 310; member interaction; Company Y]; [long term data source 310; member interaction; campaign X]. The data sources 310, 312 may be accessed asynchronously in the event of cache misses.

At 412, for the various the data aggregation categories, the processor determines individual interaction rates for the various data aggregation categories. Thus, in an abbreviated, illustrative example, for a sponsored content campaign for presentation to John Doe from Company Y on website Z would have, as example offsite interaction rates, the rate at which John Doe interacted with sponsored content items from Company Y in the past; the rate at which John Doe viewed sponsored content items from Company Y in the past; the rate at which John Doe interacted with sponsored content items on website Z in the past; the rate at which John Doe viewed sponsored content items on website Z in the past; the rate at which all members interacted with content items from Company Y on website Z in the past; and the rate at which all members viewed sponsored content items from Company Y on website Z in the past. As such, each offsite interaction rate corresponds to one data aggregation category for which data is available.

Additionally or alternatively, the processor 300 determines an offsite interaction rate by dividing the number of data points in the data aggregation category by the number of potential interactions that occurred. In an example, the interaction rate for the member John Doe for the long term data source 310 is obtained by dividing the number of data points in the [long term data source 310; member interaction; John Doe] data aggregation category by the number of data points in the [long term data source 310; shown to the member; John Doe].

$$Interaction rate = \frac{\# of data points in [ long term ; interaction ; John Doe ]}{\# of data points in [ long term ; shown to ; John Doe ]}$$

The offsite interaction rate is determined for some or all of the various data aggregation categories that can be combined according to the principles illustrated above, e.g., that have some matching data types that provide for relevant points of comparison. The operations 406-412 are performed within the same predetermined time that is allocated for operation 404 as well. In the above example, the predetermined time is ten (10) milliseconds, though it is emphasized again that the predetermined time is presented by way of illustration and not limitation.

At 414, following the completion of the predetermined time, the onsite predicted interaction rate is combined with the offsite interaction rates in a correction model to adjust the onsite predicted interaction rate with the offsite interaction rates. In various examples, the offsite interaction rates are utilized to adjust the onsite predicted interaction rate according to a logistic regression. In various examples, either the offsite interaction rates, the number of data points themselves, or both data types are utilized. The results is a corrected predicted interaction rate for a given content item.

In an example, the sponsored content module 108 determines over time coefficients that are applied to the various interaction rates, e.g., the onsite predicted interaction rate and the offsite interaction rates, to determine the predicted interaction rate. The sponsored content module 108 determines the coefficients over time utilizing logistic regression by iteratively updating the coefficients based on actual interaction with the sponsored content items in comparison with their associated predicted interaction rates. In an example, the coefficients wₙ are applied as follows:

$$P ( interaction ) = \frac{1}{1 + {e}^{- {w}_{0} + {w}_{1} * online rate + {Σ}_{x = 2}^{n} {w}_{x} * offline rates}}$$

Stated differently, coefficients w are separately applied to adjust the online predicted interaction rate and the offline interaction rates based on historical performance of those various rates. The rates, as adjusted, are then utilized to determine the predicted interaction rate.

As noted above, in an example, the operations 404-414 are performed for each sponsored content item that is considered for presentation to the member, resulting in corrected predicted interaction rates for each of the sponsored content items under consideration. The operations 404-414 are themselves performed in parallel for each of the sponsored content items, meaning that within the predetermined time the onsite predicted interaction rate and the offsite interaction rates are determined for each of the sponsored content items, following which the onsite predicted interaction rates are corrected based on the associated offsite interaction rates. The corrected predicted interaction rates are then utilized as the predicted response rates in operation 204.

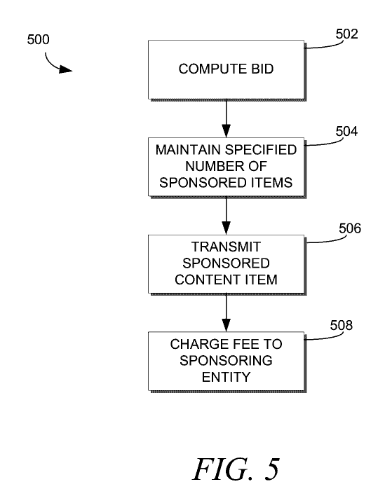

FIG. 5 is a flowchart 500 for bid optimization using the predicted response rate, in an example embodiment. The flowchart 500 may be utilized to implement operation 204 above, in various examples. However, it is emphasized that operation 204 may be implemented according to any suitable mechanism or series of operations. The flowchart 500 illustrates bid optimization in an RTB situation. However, it is again emphasized that bidding may operate according to any suitable mechanism.

At 502, the bid for the social networking system (Bid_{SNS}) is computed according to the formula

Bid_{SNS}=p(response,sponsored content item)*value(response)

where p(response) is the predicted response rate for a given content item and value(response) is the bid offered by the sponsoring entity for a given response. Alternatively, Bid_{SNS} may be computed according to an arbitrage system by

Bid_{SNS}=p(response,sponsored content item)*λ*

where λ*provides for a specified number of sponsored content items over time according to the requirements of the associated sponsored content campaign.

At 504, λ* is maintained for a sponsored content item delivery t by, if the projected delivery of a sponsored content item from the campaign is greater than an actual number of sponsored content items for the campaign, then

λ(t+1)=λ(t)*1.1

Otherwise,

λ(t+1)=λ(t)*0.9

At 506, the sponsored content module 108 transmits the sponsored content item having the highest Bid_{SNS} to the user interface of the member.

At 508, the sponsored content module 108 charges a fee to charge the sponsoring entity based on

$$cost to sponsoring entity = \frac{{Bid}_{SNS}}{p ( response )} + ( 1 * x \% )$$

where X is a predetermined fee for facilitating the presentation of the sponsored content item to the member.

System

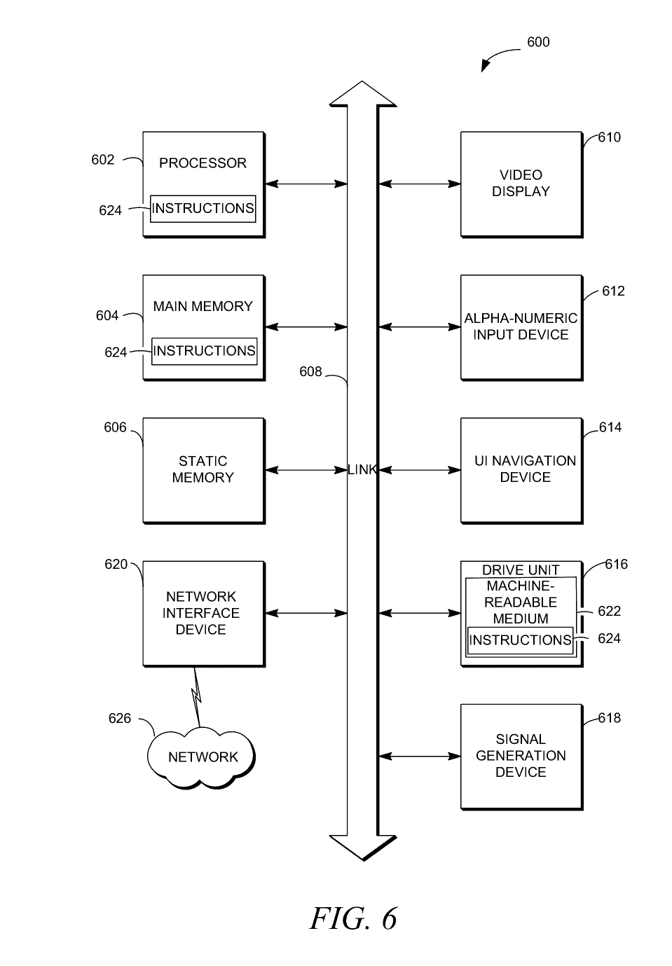

FIG. 6 is a block diagram illustrating components of a machine 600, according to some example embodiments, able to read instructions from a machine-readable medium (e.g., a machine-readable storage medium) and perform any one or more of the methodologies discussed herein. Specifically, the machine 600 may implement the social network system 100 and the features included and described therein. The machine 600 thus describes specific hardware configurations on which the social network system 100 may be implemented and provided to users of the social network system 100.

FIG. 6 shows a diagrammatic representation of the machine 600 in the example form of a computer system and within which instructions 624 (e.g., software) for causing the machine 600 to perform any one or more of the methodologies discussed herein may be executed. In alternative embodiments, the machine 600 operates as a standalone device or may be connected (e.g., networked) to other machines. In a networked deployment, the machine 600 may operate in the capacity of a server machine or a client machine in a server-client network environment, or as a peer machine in a peer-to-peer (or distributed) network environment. The machine 600 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 624, sequentially or otherwise, that specify actions to be taken by that machine. Further, while only a single machine is illustrated, the term “machine” shall also be taken to include a collection of machines that individually or jointly execute the instructions 624 to perform any one or more of the methodologies discussed herein.

The machine 600 includes a processor 602 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 604, and a static memory 606, which are configured to communicate with each other via a bus 608. The machine 600 may further include a graphics display 610 (e.g., a plasma display panel (PDP), a light emitting diode (LED) display, a liquid crystal display (LCD), a projector, or a cathode ray tube (CRT)). The machine 600 may also include an alphanumeric input device 612 (e.g., a keyboard), a cursor control device 614 (e.g., a mouse, a touchpad, a trackball, a joystick, a motion sensor, or other pointing instrument), a storage unit 616, a signal generation device 618 (e.g., a speaker), and a network interface device 620.

The storage unit 616 includes a machine-readable medium 622 on which is stored the instructions 624 (e.g., software) embodying any one or more of the methodologies or functions described herein. The instructions 624 may also reside, completely or at least partially, within the main memory 604, within the processor 602 (e.g., within the processor's cache memory), or both, during execution thereof by the machine 600. Accordingly, the main memory 604 and the processor 602 may be considered as machine-readable media. The instructions 624 may be transmitted or received over a network 626 via the network interface device 620.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 622 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., software) for execution by a machine (e.g., machine 600), such that the instructions, when executed by one or more processors of the machine (e.g., processor 602), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method, comprising:
for each sponsored content campaign of sponsored content campaigns that match characteristics of a member of an online social networking system, accessing, with a processor, during a predetermined access time, member profile data and activity data of the member from a database of the social networking system, wherein member profile data and activity data that is not accessible during the predetermined access time is not accessed;
for each of the sponsored content campaigns, calculating, with the processor, within a predetermined time including the predetermined access time, an onsite predicted interaction rate, by the member, with sponsored content items of an associated one of the sponsored content campaigns based the member profile data and the activity data as accessed from the database;
for each of the sponsored content campaigns, calculating, with the processor, in parallel with the accessing and calculating the onsite predicted interaction rate operations and within the predetermined time, an offsite predicted interaction rate, by the member, with sponsored content items of the one of the sponsored content campaigns based, at least in part, on data obtained from a third party;
for each of the sponsored content campaigns, determining a predicted interaction rate, by the member, with an associated sponsored content item based on the onsite predicted interaction rate and the offsite predicted interaction rate; and
causing, with the processor, via a network interface, a user interface of a user device to display a sponsored content item of one of the sponsored content campaigns based on the corrected predicted interaction rate.

2. The method of claim 1, wherein calculating the offsite predicted interaction rate includes accessing the data obtained from the third party from an electronic data storage different from the database.

3. The method of claim 2, wherein the electronic data storage is a cache memory.

4. The method of claim 2, wherein the electronic data storage includes a long term data source configured to store data for a first time and a short term data source configured to store data for a second time shorter than the first time, wherein calculating the offsite predicted interaction rate includes utilizing data from each of the long term data source and the short term data source.

5. The method of claim 4, wherein the data includes individual data items and wherein calculating the offsite predicted interaction rate includes classifying each individual data item as accessed from the electronic data storage according to a plurality of data aggregation categories and calculating the offsite predicted interaction rate based on the individual data items as classified into the data aggregation categories, wherein each data aggregation category is based on:
whether the individual data item was obtained from the long term data source or the short term data source;
whether the individual data item includes a user interaction with, or a user viewing of, information related to the individual data item; and
one of a predetermined set of data characteristic types of the individual data item.

6. The method of claim 5, wherein the predetermined set of data characteristic types are: a member of the social networking system to which the data item relates; an application type from which the individual data item derives; a sponsored content campaign from which the data item derives; a sponsoring entity from which the data item derives; a sponsored content application from which the data item derives; and a sponsored content campaign type from which the data item derives.

7. The method of claim 5, wherein the individual data items comprise data relating to previous incidents of sponsored content items of sponsored content item campaigns being transmitted for display to members of the social networking system.

8. A computer readable medium including instructions which, when implemented on a processor, cause the processor to perform operations comprising:
for each sponsored content campaign of sponsored content campaigns that match characteristics of a member of an online social networking system, accessing, with a processor, during a predetermined access time, member profile data and activity data of the member from a database of the social networking system, wherein member profile data and activity data that is not accessible during the predetermined access time is not accessed;
for each of the sponsored content campaigns, determining, within a predetermined time including the predetermined access time, an onsite predicted interaction rate, by the member, with sponsored content items of an associated one of the sponsored content campaigns based the member profile data and the activity data as accessed from the database;
for each of the sponsored content campaigns, calculating, with the processor, within the predetermined time, an offsite predicted interaction rate, by the member, with sponsored content items of the one of the sponsored content campaigns based, at least in part, on data obtained from a third party;
for each of the sponsored content campaigns, determining a predicted interaction rate, by the member, with an associated sponsored content item based on the onsite predicted interaction rate and the offsite predicted interaction rate; and
causing, with the processor, via a network interface, a user interface of a user device to display a sponsored content item of one of the sponsored content campaigns based on the corrected predicted interaction rate.

9. The computer readable medium of claim 8, wherein calculating the offsite predicted interaction rate includes accessing the data obtained from the third party from an electronic data storage different from the database.

10. The computer readable medium of claim 9, wherein the electronic data storage is a cache memory.

11. The computer readable medium of claim 9, wherein the electronic data storage includes a long term data source configured to store data for a first time and a short term data source configured to store data for a second time shorter than the first time, wherein calculating the offsite predicted interaction rate includes utilizing data from each of the long term data source and the short term data source.

12. The computer readable medium of claim 11, wherein the data includes individual data items and wherein calculating the offsite predicted interaction rate includes classifying each individual data item as accessed from the electronic data storage according to a plurality of data aggregation categories and calculating the offsite predicted interaction rate based on the individual data items as classified into the data aggregation categories, wherein each data aggregation category is based on:
whether the individual data item was obtained from the long term data source or the short term data source;
whether the individual data item includes a user interaction with, or a user viewing of, information related to the individual data item; and
one of a predetermined set of data characteristic types of the individual data item.

13. The computer readable medium of claim 12, wherein the predetermined set of data characteristic types are: a member of the social networking system to which the data item relates; an application type from which the individual data item derives; a sponsored content campaign from which the data item derives; a sponsoring entity from which the data item derives; a sponsored content application from which the data item derives; and a sponsored content campaign type from which the data item derives.

14. The computer readable medium of claim 12, wherein the individual data items comprise data relating to previous incidents of sponsored content items of sponsored content item campaigns being transmitted for display to members of the social networking system.

15. A system, comprising:
a computer readable medium including instructions which, when implemented on a processor, cause the processor to perform operations comprising:
for each sponsored content campaign of sponsored content campaigns that match characteristics of a member of an online social networking system, accessing, with a processor, during a predetermined access time, member profile data and activity data of the member from a database of the social networking system, wherein member profile data and activity data that is not accessible during the predetermined access time is not accessed;
for each of the sponsored content campaigns, determining, within a predetermined time including the predetermined access time, an onsite predicted interaction rate, by the member, with sponsored content items of an associated one of the sponsored content campaigns based the member profile data and the activity data as accessed from the database;
for each of the sponsored content campaigns, calculating, with the processor, within the predetermined time, an offsite predicted interaction rate, by the member, with sponsored content items of the one of the sponsored content campaigns based, at least in part, on data obtained from a third party;
for each of the sponsored content campaigns, determining a predicted interaction rate, by the member, with an associated sponsored content item based on the onsite predicted interaction rate and the offsite predicted interaction rate; and
causing, with the processor, via a network interface, a user interface of a user device to display a sponsored content item of one of the sponsored content campaigns based on the corrected predicted interaction rate.

16. The system of claim 15, wherein calculating the offsite predicted interaction rate includes accessing the data obtained from the third party from an electronic data storage different from the database.

17. The system of claim 16, further comprising the processor, the database, and the electronic data storage.

18. The system of claim 16, wherein the electronic data storage is a cache memory.

19. The system of claim 16, wherein the electronic data storage includes a long term data source configured to store data for a first time and a short term data source configured to store data for a second time shorter than the first time, wherein calculating the offsite predicted interaction rate includes utilizing data from each of the long term data source and the short term data source.

20. The system of claim 19, wherein the data includes individual data items and wherein calculating the offsite predicted interaction rate includes classifying each individual data item as accessed from the electronic data storage according to a plurality of data aggregation categories and calculating the offsite predicted interaction rate based on the individual data items as classified into the data aggregation categories, wherein each data aggregation category is based on:
whether the individual data item was obtained from the long term data source or the short term data source;
whether the individual data item includes a user interaction with, or a user viewing of, information related to the individual data item; and
one of a predetermined set of data characteristic types of the individual data item.
